(19) United States
(12) Patent Application Publication
(10) Pub. No.: US 2013/0126735 A1
(43) Pub. Date: May 23, 2013

(54) RADIATION SENSOR

(71) Applicants: Fred Plotz, Tanunsstein (DE); Gerhard Knaup, Einhausen (DE); Thomas Kastner, Rheinstetten (DE); Stefan Naumann, Dreieich (DE); Henrik Ernst, Katzenelnbogen (DE)

(72) Inventors: Fred Plotz, Tanunsstein (DE); Gerhard Knaup, Einhausen (DE); Thomas Kastner, Rheinstetten (DE); Stefan Naumann, Dreieich (DE); Henrik Ernst, Katzenelnbogen (DE)

(73) Assignee: EXCELITAS TECHNOLOGIES GMBH & CO., KG, Wiesbaden (DE)

(21) Appl. No.: 13/637,888

(22) PCT Filed: Mar. 24, 2011
(86) PCT No.: PCT/EP11/01490

§ 371 Date: Oct. 17, 2012

(30) Foreign Application Priority Data
Apr. 1, 2010 (DE) 10 2010 013 661.1

(51) Int. Cl. G01J 5/10; G01J 5/08; G01J 5/34

(52) U.S. Cl. CPC G01J 5/10; G01J 5/34; G01J 5/08
USPC 250/338.3; 250/338.1; 250/353

(57) ABSTRACT

A radiation sensor (10) comprises one or more radiation sensing elements (1) providing an electric signal in dependence of incident radiation, a housing (4, 5) confining the sensing element and permitting incidence of radiation from outside onto the sensing element, plural terminals (7) for supplying electrical power to the sensor and at least for outputting a sensor output signal, and circuitry (2) receiving the electric signal of the sensing element and providing the output signal in accordance with the electric signal of the sensing element. The circuitry comprises a switching signal circuitry for generating an on/off output signal for a switchable component external to the sensor and/or a digital output signal circuitry for providing a multiple bit serial output signal, and the sensor has one output terminal (7a) for outputting the on/off output signal or the multiple bit serial output signal.

The invention relates to a radiation sensor according to the preamble of the independent claim. Such a radiation sensor is known from DE 19735379 and from DE 10 2004 028022.

Radiation sensors convert incident radiation into electrical signals for detection. The detection may be of qualitative or quantitative nature.

Qualitative detection is, for example, motion detection within the field of view of the sensor. Quantitative detection may be thermometry for temperature detection, e.g. measuring temperature of the human body.

One or more sensing elements in the sensor convert radiation into electrical signals and shape and format them appropriately. Since usually the incident signals are very weak, shaping includes usually at least amplification and/or impedance conversion. Filtering may also be made. Such shaped signals are output for further processing for accomplishing the desired qualitative or quantitative detection. Qualitative detection may comprise an intensity—threshold comparison. Quantitative detection may comprise an intensity—temperature signal conversion.

Often, resolution in space is desired within the field of view of the sensor. The sensor then has some kind of beam shaping elements, for example some kind of lens or mirror in its housing for converging or focussing incident radiation onto sensing elements. Plural sensing elements may be provided so that depending on which of them receives converged or focussed radiation, one particular sensing element outputs a signal so that one may infer spatial information from the different outputs of the respective sensing elements.

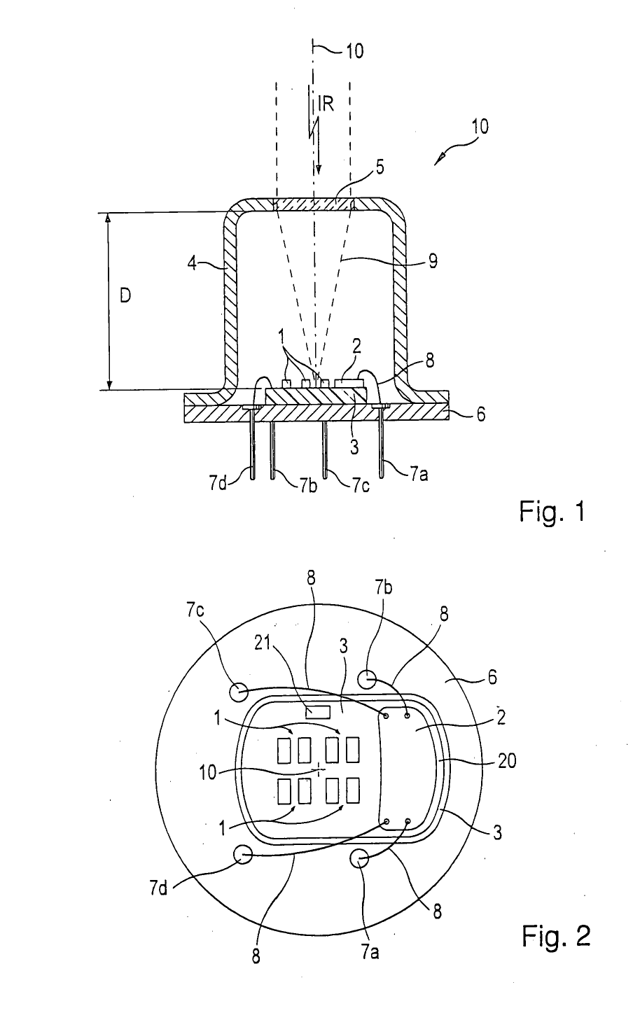

FIG. 1 shows a typical construction of a sensor 10 in side-cut view. The radiation to be measured is often infrared radiation with a maximum of sensitivity in a wavelength region above 1 μm. In FIG. 1, 1 designates plural sensing elements outputting independent of each other electric output signals in dependence of the respectively incident radiation. The incident radiation is symbolized by beam 9. Falling onto the sensor 10 it may be assumed to be parallel radiation because, the radiation source is usually remote compared to the sensor dimension. Beam converging means 5, for example provided as a part of the overall housing 4-6, converge the radiation onto the sensing element 1. Converging may be focussing, and the sensing elements 1 lay in the focal plane. The beam converging means 5 may be a lens, particularly a spherical lens with an optical axis parallel to, or coinciding with, an axis of the housing. 11 indicates an axis that is an optical axis of the converging means 5, coinciding with a symmetry axis of the housing cup 4 which may be of generally tubular shape.

Provided is also some kind of circuitry 2 receiving signals from the sensing element 1. The sensor further has terminals 7 which may include power terminals for power supply to the electric components within the sensor, and input and output terminals for inputting control signals and outputting signals in dependence of the incident radiation.

Known sensors suffer from the disadvantage that their output signals are affected by noise and thus do not precisely reflect the situation to be detected, and are complicated to use and thus require further external processing.

It is the object of the invention to provide a sensor for radiation providing a correct and easy to use output signal.

This object is accomplished by the features of claim 1. Dependent claims are directed on preferred embodiments of the invention.

A radiation sensor comprises one or more radiation sensing elements and circuitry receiving the electric signal of the sensing elements and providing a sensor output signal in accordance with the electric signal of the sensing element. The circuitry comprises either a switching signal circuitry for generating an on/off output signal for a switchable component external to the sensor, or comprises a digital output signal circuitry for providing a multiple bit serial output signal. The sensor further has one, preferably only one output terminal for outputting the on/off output signal or the multiple bit serial output signal or both in an alternating manner.

With the mentioned features, the output signal is easy to use because it is output by the sensor in a “ready-to-use” format. Providing only one output terminal reduces affection of internal components by external noise because all together few terminals are provided which collect only low amounts of external noise.

The circuitry provided inside the sensor housing may be designed to have a power consumption of less than 50 μW, preferably smaller than 20 μW or smaller than 10 μW. The consumed power is converted into heat, and thus heating power inside the sensor is below the mentioned values so that internal heating up and thus internally generated sensing distortions are kept small and on a negligible level.

A temperature reference element may be provided for measuring the temperature of relevant parts of the sensor for considering it in signal evaluation.

The sensing elements may be thermopiles, bolometers or pyroelectric sensing elements. They may be provided pair-wise for common mode suppression. Plural sensing elements may be provided as an array (longitudinal arrangement) or as a matrix (covering a certain area) for allowing spatial resolution.

The sensing elements may be provided with absorption and/or reflection layers for improving/reducing absorption of the incident radiation.

The circuitry may comprise a digital part for accomplishing a digital signal processing and may comprise an A/D converter (AD-converter) for converting analogue signals into digital signals, wherein the latter may be provided in plural parallel bits or as a serial bit stream.

Filtering means may be provided in the optical path or in the analogue signal path or in the digital signal path.

The housing may be of relatively good thermal conductivity. Particularly, it may have a thermal conductivity better than 20% of that of pure copper, preferably better than 50% thereof.

Further, the housing may be electrical conductive for shielding the internal circuitry against external electromagnetic radiation, this reducing its impact on the internal circuitry.

The housing may have standardized dimensions, for example, following the TO5 standard or the TO46 standard. It may also be formed as an SMD (surface mounted device).

In the following, embodiments of the invention will be described with reference to the attached drawings, in which

FIG. 1 is a sectional view of a sensor to which the invention may be applied,

FIG. 2 is a plane view on the internal instructions of the sensor, and

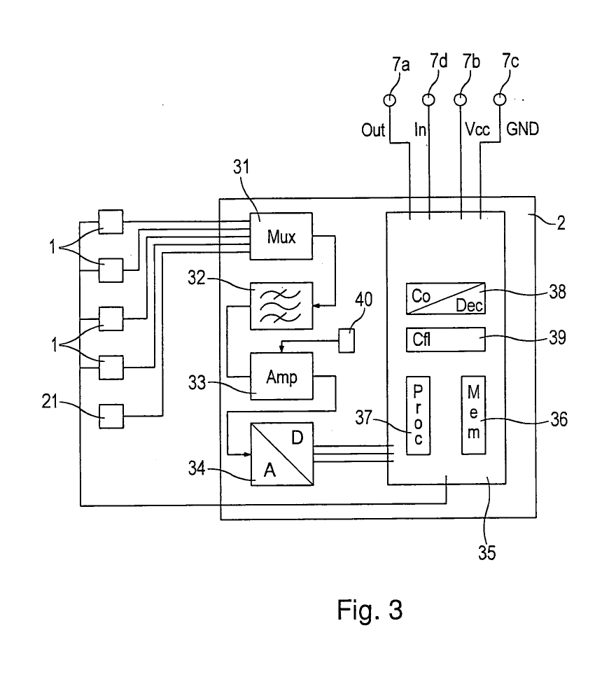

FIG. 3 is a block circuit diagram of the internal signal processing of the sensor.

FIG. 1 shows a sensor to which the invention may be applied. A circuit board 3 carries sensing elements 1 and circuitry 2. A base plate 6 of a housing 4-6 is pierced by terminals 7 which in turn are connected to the circuitry 2 and/or the sensing elements 1, for example by bonding, indicated by 8. The circuit board 3 may be provided on the base plate 6. In the shown embodiment, the sensor comprises only one output terminal 7a for outputting the detection signal.

FIG. 2 shows a plain view on the open sensor. On a base plate 6 of the sensor a little circuit board 3 is provide supporting a substrate 20 that carries the sensing elements 1 and the circuitry 2, preferably formed as an ASIC. Numerals 7a to 7d symbolize the inside ends of terminals 7 reaching to the outside as shown in FIG. 1. They may at the inner end be widened up and prepared for bonding. Bonding wires 8 may go from the terminal ends to appropriate counter terminals, for example on circuitry/ASIC 2. The sensing elements 1 may also be connected to ASIC 2 via bonding connections or other kind of wiring.

21 symbolizes a temperature reference sensor sensing the temperature of a relevant part of the sensor. The relevant part may be the substrate carrying the sensing elements 1. But likewise, the temperature sensor 21 may be integrated into ASIC 2. It is also connected to circuitry 2 by appropriate means. Its output signal may be considered in evaluating the signals from the sensing elements 1.

All together, there may be provided a stack of housing base plates 6, circuit board 3, substrate 20 and sensing element 1 and circuitry 2 on said substrate 20.

The beam converging means 5 may be a lens or a Fresnel lens. Its distance D from the plane in which the sensing elements 1 are provided may be the focal length of the lens or may be offset therefrom in z-direction (towards or away from the lens) by a defined value.

In FIG. 2, 10 symbolizes the optical axis of the beam converging means 5. The sensing elements 1 may be provided symmetrically with respect to the optical axis or in a certain manner asymmetrically.

The sensing elements 1 may be provided with common mode suppression. Sensing elements for infrared radiation usually provide a DC-signal at their terminals. The arrangement may be such that signal components received by two sensing elements in the same way (common mode) cancel each other. This is achieved by connecting two sensing elements in series or parallel with opposing polarity, i.e. in a series connection either connecting the respective plus terminals or the respective minus terminals, and in a parallel connection connecting plus of the one to minus of the other sensing element. Then, the common mode cancels out and only focused radiation from a distinct source, hitting only one of the sensing elements, will lead to a signal because it is not cancelled out by a same, oppositely polarized signal component from the respective other sensing element. Through this, disturbing quantities such as temperature rise of the overall device or wide spread radiation sources such as surfaces heating up upon incidence sunlight, do not lead to miss-detections. The connected sensing elements may be adjacent to each other or more remote than the dimension of one sensing element.

The circuitry 2 inside the sensor is constructed such that it has a power consumption of less than 50 μW, preferably smaller than 20 μW or smaller 10 μW in operation mode. Consumed power is transformed into heat. By making the design such that the consumed electric power is small, also the obtained heating power is small. Then, the internal heating does not lead to misdetections. It has shown that heat generated by the internal circuitry itself may significantly contribute to misdetections. The sensing elements 1 usually operate on the basis of converting incident radiation into heat sensed by the sensing elements. The sensing elements cannot distinguish between heat generated by incident radiation or heat generated by nearby internal circuitry. Thus, for minimizing misdetections from heating by circuit power, circuit power is designed to be relatively small as mentioned above.

For avoiding temperature variations due to varying power consumption due to varying internal sensor operation states (e.g. standby vs. heavy computing), the design can be made such that power consumption in the various operation states (maximum power Pmax, minimum power Pmin) differs only by a predetermined amount. For example, the ration Pmax/Pmin may be lower than 3, less than 2, less than 1.5 or less than 1.2, or the difference Pmax−Pmin may be lower than 10 μW, 5 μW, 2 μW or 1 μW.

This may be achieved by appropriately designing inherent properties of the circuitry. Dedicated power consumption control means may be provided, such as a power consumption controller which may include an appropriately controlled dummy consumer for keeping power consumption above a certain level defined in relation to the maximum possible power consumption of all possible operation states. The power consumption controller may increase power consumption, e.g. in said dummy consumer or in another component when otherwise consumption is low. Through this, power consumption is relatively uniform, and in consequence internal heating power is relatively uniform, and accordingly temperature variations caused thereby are relatively low.

The circuitry 2 includes the switching signal circuitry for generating said on/off output signal or the digital output signal circuitry for providing said multiple bit serial output signal. It is schematically connected between sensing elements 1 and output terminal 7a.

The beam converging means 5 may be made of IR transparent material. It may comprise silicon or germanium as main constituent or a mixture thereof. The lens may be shaped by micromachining.

Filtering in the optical path may be accomplished by providing filtering layers, for example on the beam converging means 5, such as providing a lens or a Fresnel lens with filtering layers. They may be shaped as anti-reflex layers or as band-pass or low pass or high pass layers. Plural of them may be provided in a stacked manner for designing the desired transmission characteristics. The optical filtering may comprise more than 5 or more than 10 or more than 20 layers.

For avoiding thermal imbalance of the overall sensor, the housing of the sensor may comprise material of relatively good thermal conductivity. It may be better than 20% or better than 50% of that of pure copper. The sensor housing 4-6 may comprise a metallic cap 4 formed of the mentioned material and carrying a radiation inlet such as the converging means 5 in an appropriate manner, particularly concentrically. Through this, thermal imbalance of the sensor is reduced so that likewise misdetections from thermal imbalance are reduced.

The reflectivity of sensor-internal walls of the housing (cap) may be less than 0.5, less than 0.2 or less than 0.1, i.e. less than 50%, 20%, 10% of the incident radiation being reflected. For selected applications it may be less than 5% or less than 1%. This serves to minimize the impact of radiation entering sideways of the intended radiation path through converging means 5 and potentially finding its way to the sensing elements through internal reflection. It is quickly absorbed and does not contribute to the signal at the sensing element.

FIG. 3 shows schematically a block diagram of the circuitry provided within the housing of sensor 10. Circuitry 2 may be an ASIC (application specific integrated circuit) and may comprise an analogue part and digital part and an AD-converter. The ASIC may comprise all mentioned components and functionalities within one chip. An AD-converter may be a link between analogue components and digital components.

The analogue components may comprise some kind of amplification 33 of the signals from the sensing elements 1. Amplification factor may be chosen as required and may also be 1 or smaller than 1. Amplification may include impedance conversion for obtaining stronger signals for subsequent evaluation.

32 may be an analogue filter filtering out signal quantities untypical for the situation to be detected. It may be a low pass filter filtering out frequencies, for example, higher than 10 Hz or higher than 5 Hz or higher than 2 Hz.

If plural sensing elements 1 are provided, there may some kind of multiplexer 31 be provided for serially polling the individual elements 1 and providing their output one after another to the input of the respectively provided analogue components. Likewise, the temperature reference sensor 21 may be connected to the multiplexer 31. But likewise, it may go more or less directly through AD-conversion 34.

The mentioned components may be under control of a controller 39 provided in the digital circuit part.

The digital circuit part, indicated by 35, may comprise a memory 36 for storing program data, input data, temporary data, measurement data, history data and the like.

A processor 37 may be provided for rendering the intended main functionality, particularly for implementing the switching signal circuitry for generating an on/off output signal and/or for implementing the digital output signal circuitry for providing a multiple bit serial output signal.

For accomplishing these functionalities and generating the mentioned output signals, the processor 37 may run appropriate programs for evaluating the measured values and potentially also values input from external through one of the terminals.

When implementing the switching signal circuitry for generating and on/off output signal, the processor may compare one or more of the measured values received from AD-converter 34 with predefined or adjusted threshold values, and generate a detection signal when the threshold is exceeded. The threshold may be defined by an external input from an input terminal for defining sensitivity of the sensor. After a positive detection was found, an output signal may switch over from a first to a second state (off to on). It may be reset (to first=off state) according to predetermined criteria also implemented by processor 37. The criteria may be resetting when the measured signal disappears or resetting after a predetermined time (such as 2 seconds) or resetting after a time determined by an input signal received through one of the input terminals. The output of the processor may be given to the output terminal 7a. Its characteristics (amplitude and/or internal resistance and/or frequency and/or coding) may be such that it is suitable for immediately driving external switching components that may directly be connected to the sensor. The two states (on/off) may be reflected by different voltages. The voltage difference between the two voltages may be more than 0.2 Volts or more than 0.5 Volts or more than 1 Volt. The output resistance at the output terminal 7a may be less than 100 Ohms or less than 50, 20 or 10 Ohms.

When embodying a digitally coded, quantitative output signal circuitry, the processor 37 may again make evaluations of the measured signals coming from the AD-converter 34 which in turn received input from one or more sensing elements 1. The evaluation may be made under given criteria reflected by a program stored in memory 36. The result of the evaluations may lead to a quantitative value, for example for reflecting a temperature value. This value may be given to a Codec (coding/decoding circuit) 38 which may encode the quantitative value into a serial bit stream of a predefined coding scheme. This may be given to the output terminal 7a. By the Codec 38 the serial signal is again shaped (amplitude, bit duration, internal resistance) to be suitable for being immediately received by external (listening) components conforming to the chosen encoding scheme. Codec 38 may operate in accordance with a known coding scheme, such as binary or the like.

The sensor may be adapted to implement both a switching signal circuitry and a digital output signal circuitry in a selectable manner, selectable for example by an input signal through one of the terminals 7.

The sensor may have three terminals 7, namely one output terminal 7a and two power terminals 7b for supply voltage and 7c for ground. The output terminal 7a outputs the digital serial output signal or the switching signal mentioned above or the two in an alternating manner. The sensor may also have a fourth terminal 7d for an input signal. It may be a sensitivity setting signal or an on-time setting signal or an enable signal or a selection signal or a synchronization signal for synchronizing sensor-internal cycles/timings to external requirements. The sensor may also comprise more than one input terminal. It may comprise input terminals for each of the mentioned input quantities, i.e. one terminal for sensitivity setting, one terminal for on-time setting one terminal for enable setting, one input terminal for the above mentioned selection signal and one input signal for the synchronization signal.

39 designates a control section controlling the functionalities of the respective analogue and digital components. Technically, the digital circuit part 35 may have a CPU that implements at appropriate times the processor 37, the controller 39 and the Codec 38.

The controller 39 may control operation of the multiplexer 31, filter 32, AD-converter 34 and of the digital components.

The Codec 38 may also be used for decoding coded input data from one of the input terminals.

The enable input may receive a signal from a light sensing device so that outputting an on/off output signal of a switching signal circuitry is avoided when presence of light is already detected. This avoids operation, for example, during daytime.

Sensitivity of the sensor may be defined through mask programming on chip level, preferably on the ASIC. The circuitry 2 may comprise structures that may permanently be modified for obtaining a desired sensitivity. This may be done in the analogue signal part or in the digital signal part. It is indicated by numeral 40 in FIG. 3 and is, shown there as a part of the analogue branch, influencing operation of filter 32 and/or amplifier 33. But likewise, it may be provided in the digital circuit part 35.

In its external appearance, the sensor may be dimensioned according to certain standards, such as TO5 or TO46. The sensor may also be formed as a surface mount device (SMD) having contact areas or contact bumps on one of the surfaces thereof.

The above described features relating to sensor internal power consumption (such as maximum value, dummy consumer, consumption control and others) may be used also independent of the format of the output signal and independent of the number of terminals of the sensor, i.e. without said features.

Features described in this specification shall be deemed combinable with each other as far as their combination is not excluded by technical reasons. Likewise, the feature's described with reference to prior art may also be used in combination with features of the invention, as far as not being in contradiction thereto.

1. A radiation sensor (10) comprising
one or more radiation sensing elements (1) providing an electric signal in dependence of incident radiation,
a housing (4-6) confining the sensing element and permitting incidence of radiation from outside onto the sensing element,
plural terminals (7) for supplying electrical power to the sensor and for outputting a sensor output signal, and
circuitry (2) receiving the electric signal of the sensing element and providing the output signal in accordance with the electric signal of the sensing element,
characterized in that
the circuitry comprises a switching signal circuitry for generating an on/off output signal for a switchable component external to the sensor and/or a digital output signal circuitry for providing a multiple bit serial output signal, and
the sensor has one output terminal (7a) for outputting the on/off output signal or the multiple bit serial output signal.

2. The sensor of claim 1 comprising one or more input terminals (7d) for receiving one or more of an enable signal, a sensitivity setting signal or an switching signal duration setting signal.

3. The sensor of claim 1, wherein the power consumption of the circuitry provided inside the housing is smaller than 50 μW, preferably smaller than 20 μW or smaller than 10 μW.

4. The sensor of claim 1, having four terminals, namely two power terminals (7b,c), one signal output terminal (7a) and one input terminal (7d).

5. The sensor of claim 1, wherein the switching signal circuitry is adapted to generating the on/off output signal of a predetermined duration or of a duration in accordance with a received input signal.

6. The sensor of claim 1, comprising an A/D converter for converting an analog quantity into a serial or parallel digital quantity, wherein the A/D converter input may be multiplexable amongst the electrical signal of the sensing element or a signal derived therefrom and at least one input signal input through at least one of the input terminals.

7. The sensor of claim 1, comprising a temperature reference element connected to the circuitry for detecting a reference temperature of the sensor element.

8. The sensor of claim 1, wherein the sensing element is or comprises a thermopile, a bolometer or a pyroelectric sensing element, and/or is adapted to detecting infrared radiation, preferably in a range of wavelength of 2 μm to 20 μm.

9. The sensor of claim 1, comprising a radiation converging means (5) converging incident radiation in a convergence plane, and plural sensing elements arranged in a defined relationship with reference to said plane.

10. The sensor of claim 1, wherein one or plural pairs of polar sensing elements are provided, the sensing elements of the pairs being connected for delivering a common electric signal with common mode suppression.

11. The sensor of claim 1, wherein the circuitry, comprises an integrated circuit, preferably an ASIC, comprising preferably an A/D converter (2b) for analog-digital converting signals, particularly one or more of an electric signal generated in accordance with an electric signal of a sensing element or an analog input signal, and comprising a digital signal processing part (2c), which may comprise one or more of
a memory part for storing one or more of input data, program data, measured data, intermediate data,
coding and/or decoding means for encoding data to be output and/or for decoding input data,
multiplexing commanding means for controlling connection of input and/or of output of the A/D converting means and/or of the coding and/or decoding means,
computing means for processing signals derived from the output of the sensing element,
wherein the ASIC may further comprise an analog circuit part (2a) that comprises one or more of
amplification means for amplifying the electric signal from the sensing element,
impedance converting means connectable to a sensing element,
filtering means.

12. The sensor of claim 1, comprising a radiation converging means (5), preferably formed as a part of the housing, and formed as a continuous, preferably spherical lens or as a Fresnel lens, preferably made of silicon and/or germanium as main constituents.

13. The sensor of claim 1, comprising filtering means for filtering the radiation incident on the sensing elements, preferably formed as one or a plurality of layers on a radiation converging means as an anti-reflex layer and/or a band pass layer.

14. The sensor of claim 1, wherein the housing comprises a cap made of material of electrical conductivity and/or of a thermal conductivity of at least 20% or at least 50% of that of pure copper.

15. The sensor of claim 1, comprising power consumption control means, particularly adapted to controlling sensor-internal power consumption of the circuitry (2) not to fall below a certain value, the certain value preferably being defined in relation to a maximum possible power consumption of said circuitry.

16. The sensor of claim 1, formed as an SMD or having a housing of standardized configuration, preferably TO5 or TO46.
